(19) United States
(12) Patent Application Publication
(10) Pub. No.: US 2006/0197723 A1
(43) Pub. Date: Sep. 7, 2006

(54) Reflective fluidics matrix display particularly suited for large format applications

(76) Inventors: Robert M. Sikora, San Jose, CA (US); Sean P. McMahon, Santa Clara, CA (US)

Correspondence Address: John P. McMahon, 54 East Case Drive, Hudson, OH, 44236, US

(21) Appl. No.: 11/069,680

(22) Filed: Mar. 1, 2005

(51) Int. Cl. G09G 3/34

(52) U.S. Cl. 345/84

(57) ABSTRACT

A fluid matrix display is disclosed which is a reflective display that utilizes four colored dyes to create an image. Each of the dyes corresponds to one color in a CMYK color space. Each individually addressable pixel element of the fluid matrix display is composed of four-stacked pixel chambers. Images are created by writing appropriate colored dye data into each pixel chambers of each pixel element of the fluid matrix display. Each pixel chamber is valved to admit or expunge the colored dye to and from that pixel chamber. The admitting and expunging is controlled by the use of electrorhelogic fluids, which provides for a relatively simple switching arrangement to activate and deactivate the pixel assemblies.

### CROSS REFERENCE TO RELATED APPLICATIONS

This application is related to U.S. patent application Ser. No. 10/988,279 filed Nov. 13, 2004. This application is also related to U.S. patent application Ser. No. ______ having Attorney Docket No. SP 004 and filed herewith.

### FIELD OF THE INVENTION

The invention relates to display subsystems and, more particularly, to a reflective microfluidics display particularly suited for large format applications that relies upon illumination from outside the display to strike the display and illuminate the image thereof, as opposed to an active display that produces illumination from within and consumes relatively more power thereof

### BACKGROUND OF THE INVENTION

All displays, whether active or passive, must adhere to a color model. Red, green, blue (RGB) and its subset cyan, magenta, yellow (CMY) form the most basic and well-known color models. These models bear the closest resemblance to how humans perceive color. These models also correspond to the principles of additive and subtractive colors. Although these principles are applicable to all displays, these principles are of particular importance to the present invention and are to be further discussed herein.

Additive colors are created by mixing spectral light in varying combinations. The most common examples of this are television screens and computer monitors, which produce colored pixels by firing red, green, and blue electron guns at phosphors on the television or monitor screen. More precisely, additive color is produced by any combination of solid spectral colors that are optically mixed by being placed closely together, or by being presented to a human viewer in very rapid succession. Under either of these circumstances, two or more colors may be perceived as one color. This can be illustrated by a technique used in the earliest experiments with additive colors: color wheels. These are disks whose surface is divided into areas of solid colors. When attached to a motor and spun at high speed, the human eye cannot distinguish between the separate colors, but rather sees a composite of the colors on the disk.

Subtractive colors are seen by a human viewer when pigments in an object absorb certain wavelengths of white light while reflecting the rest of the wavelengths. Humans see examples of this principle all around them. More particularly, any colored object, whether natural or man-made, absorbs some wavelengths of light and reflects or transmits others; the wavelengths left in the reflected/transmitted light make up the color humans see.

This subtractive color principle is the nature of color print production involving cyan, magenta, and yellow, as used in four-color process printing. The colors cyan (C), magenta (M) and yellow (Y) are considered to be the subtractive primaries. The subtractive color model in printing operates not only with CMY, but also with spot colors, that is, pre-mixed inks.

Red, green, and blue are the primary stimuli for human color perception and are the primary additive colors and the relationship between the colors red, green, and blue, (known in the art) as well as cyan, magenta, and yellow (also known in the art) comprising the CMYK ingredients, where K signifies the color black, can be seen in FIG. 1 herein with regard to illustration 10. The formation of the color related to the RGB and CMYK color principles are shown by the illustration 12 of FIG. 2.

As may be seen in FIG. 2, the secondary colors of RGB, cyan, magenta, and yellow, are formed by the mixture of two of the primaries and the exclusion of the third. For example, red and green combine to make yellow, green and blue combine to make cyan, and blue and red combine to make magenta. The combination of red, green, and blue in full intensity makes white (shown in FIG. 1). White light is created when all colors of the EM spectrum converge in full intensity.

The importance of RGB as a color model is that it relates very closely to the way humans perceive color striking their receptors in their retinas. RGB is the basic color model used in television or any other medium that projects the color. RGB is the basic color model on computers and is used for Web graphics, but is not used for print production.

Cyan, magenta, and yellow correspond roughly to the primary colors in art production: blue, red, and yellow. FIG. 2 also shows the CMY counterpart to the RGB model.

As is known in the art, the primary colors of the CMY model are the secondary colors of RGB, and, similarly, the primary colors of RGB are the secondary colors of the CMY model. However, the colors created by the subtractive model of CMY do not exactly look like the colors created in the additive model of RGB. Particularly, the CMY model cannot reproduce the brightness of RGB colors. In addition, the CMY gamut is much smaller than the RGB gamut.

As seen in FIG. 3 for illustration 14, the CMY model used in printing lays down overlapping layers of varying percentages of transparent cyan, magenta, and yellow inks. As further seen in FIG. 3, white light is transmitted through the inks and reflects off the white surface below them (termed the substrate 16). The percentages of CMY ink (which are applied as screens of halftone dots), subtract inverse percentages of RGB from the reflected light so that humans see a particular color.

In the illustration 14 of FIG. 3 showing one example, the white substrate 16 reflects essentially 100% of the white light which is used for printing in cooperation with a 17% screen of magenta, a 100% screen of cyan, and an 87% screen of yellow. Magenta subtracts green wavelengths from the reflected light, cyan subtracts red wavelengths from the reflected light, and yellow subtracts blue wavelengths from the reflected light. The reflected light leaving the magenta screen, is made up of 0% of the red wavelengths, 44% of the green wavelengths, and 29% of the blue wavelengths.

When the reflected light is used for printing on paper, the screens of the three transparent inks (cyan, magenta, and yellow) are positioned in a controlled dot pattern called a rosette. To the naked eye, the appearance of the rosette is of a continuous tone, however when examined closely, the dots become apparent.

When used in printing on paper, the cyan screen at 100% prints as a solid layer; the 87% layer of yellow appears as green dots because in every case the yellow is overlaying the cyan, forming green. The magenta dots, at 17%, appear much darker because they are mostly overlaying both the cyan and yellow.

In theory, the combination of cyan (C), magenta (M), and yellow (Y) at 100%, create black (all light being absorbed). In practice, however, CMY usually cannot be used alone because imperfections in the inks and other limitations of the process mean full and equal absorption of the light are not possible. Because of these imperfections, true black or true grays cannot be created by mixing the inks in equal proportions. The actual result of doing so results in a muddy brown color. In order to boost grays and shadows, and provide a genuine black, printers resort to adding black ink, indicated as K in the CMYK method. Thus, the practical application of the CMY color model is a four color CMYK process.

This CMYK process was created to print continuous tone color images like photographs. Unlike solid colors, the halftone dot for each screen in these images varies in size and continuity according to the image's tonal range. However, the images are still made up of superimposed screens of cyan, magenta, yellow, and black inks arranged in rosettes.

In the process involving CMYK printing, though it is chiefly regarded as being dependent upon subtractive colors, the process is also an additive model in a certain sense. More particularly, the arrangement of cyan, magenta, yellow and black dots involved in printing appear to the human eye as colors because of an optical illusion. Humans cannot distinguish the separate dots at normal viewing size so humans perceive colors, which are an additive mixture of the varying amounts of the CMYK inks on any portion of the image surface.

The CMYK process involving the interactions of its ingredients has many benefits. One of the benefits is that the net resulting color does not require an external source, such as found in the RGB process related to active display systems, involving internal electron guns causing the excitation of phosphors on television and monitor displays. It is desired that an inactive display be provided that is free of any internal illumination source, such as electron guns and that uses a CMYK process and the attendant benefits thereof. It is further desired that an inactive display be provided using a CMYK process that serves the needs of outdoor advertising.

Inactive displays using a CMYK process are known in the art and are commonly referred to as fluidic displays with one such display described in U.S. Pat. No. 6,037,955 ('955) entitled “Microfluidic Image Display.” The display disclosed in the '955 patent provides for a plurality of colored pixels, but requires the manipulation of at least first and second colored liquids for each chamber of each pixel. It is desired that an inactive display be provided that does not suffer the drawbacks of using at least first and second colored liquid for each chamber of each of the pixels being displayed.

An inactive display that is free of the limitation of using at least first and second colored liquids for each display is disclosed in our U.S. Pat. No. 6,747,777B1 issued Jun. 8, 2004, with the disclosure thereof being herein incorporated by reference. Although the display described in our patent serves well its intended purpose, it is desired that further improvements be provided to microfluidics displays.

Another inactive display that is free of the limitations of U.S. Pat. No. 6,037,955 is disclosed in our U.S. patent application Ser. No. 10/988,279 filed Nov. 13, 2004, with the disclosure thereof being herein incorporated by reference. Although the display described in our patent application serves well its intended purpose, it is desired that further improvements be provided to microfluidics displays, especially directed to simplifying the electronic selection arrangement for activating the individual pixel assemblies of the display.

### OBJECTS OF THE INVENTION

It is a primary object of the present invention to provide an inactive display that is free of any internal illumination source and that uses a CMYK process and is particularly suited to serve the needs of outdoor advertising.

It is another object of the present invention to provide a fluidics matrix display that utilizes the mixture techniques of the CMYK process to supply an image thereof and that may be updated or changed in a relatively rapid manner.

Further still, it is another object of the present invention to provide for a reflective display panel responsive to pressurized communication paths and that preferably utilizes colored dyes.

In addition, it is an object of the present invention to provide a relatively simple switching arrangement to control the activation of the pixel assemblies of the display while at the same time reducing the number of pneumatic valves that are involved.

Still further, it is an object of the present invention to provide a fluidics matrix display that utilizes electrorhelogic fluids to simplify switching arrangements to control pixel assemblies of the display.

Furthermore, it is an object of the present invention to provide individually addressable pixel elements composed of four stacked pixel chambers and with each pixel chamber being valved to admit or expunge the colored die to or from that pixel chamber. The admitting and expunging being controlled by the utilization of electrorhelogic fluids.

### SUMMARY OF THE INVENTION

The present invention is directed to a fluidic matrix display system for large format applications that is particularly suited to the needs of indoor and outdoor advertising and utilizes the illumination from outside the display to illuminate the image being displayed. The system includes an addressing scheme, which serves three important functions. First, the scheme allows for the independent addressing of each pixel element so as to create an image where each pixel element will change from one image to the next image. Second, the scheme provides memory so a new image may be written while the current image is still being displayed. Third, the creation and maintenance of the display being controlled, in part, by the utilization of electrorhelogic fluids.

The fluidics matrix display comprises: a) a plurality of pixel elements each comprising: a₁) a plurality of pixel chambers stacked on each other and with each pixel chamber having an input port and an output port; a₂) a plurality of air spring chambers each having an input port connected to a respective output port of the plurality of pixel chambers; and a₃) a plurality of valves each having input, output, and control ports and each control port being responsive to a control signal so as to interconnect its associated input to its associated output port. The output ports thereof being connected to a respective input of the plurality of the pixel chambers. The fluidics matrix display further comprises: b) a plurality of sources of pressurized colored fluids respectively connected to a respective input port of the plurality of valves; and c) an electrorhelogical switch for generating the control signal. The electrorhelogical switch comprises: c₁) a chamber having a roof and a floor and input and output ports. The input port being capable of receiving electrorhelogical fluid. The electrorhelogical switch further comprises: c₂) first and second electrodes oppositely disposed from each other and respectively located on the roof and on the floor. The first electrode being capable of being connected to a negative or ground potential and the second electrode being capable of being connected to a positive potential with the positive potential being deterministic of the generation of the control signal.

### BRIEF DESCRIPTION OF THE DRAWINGS

Features and advantages of the invention, as well as the invention itself, will become better understood by reference to the following description when considered in conjunction with the accompanying drawings, wherein like reference numbers designate identical or corresponding parts thereof and wherein:

FIG. 1 is a prior art illustration showing the interrelationship of the ingredients of the RGB and CMYK color models;

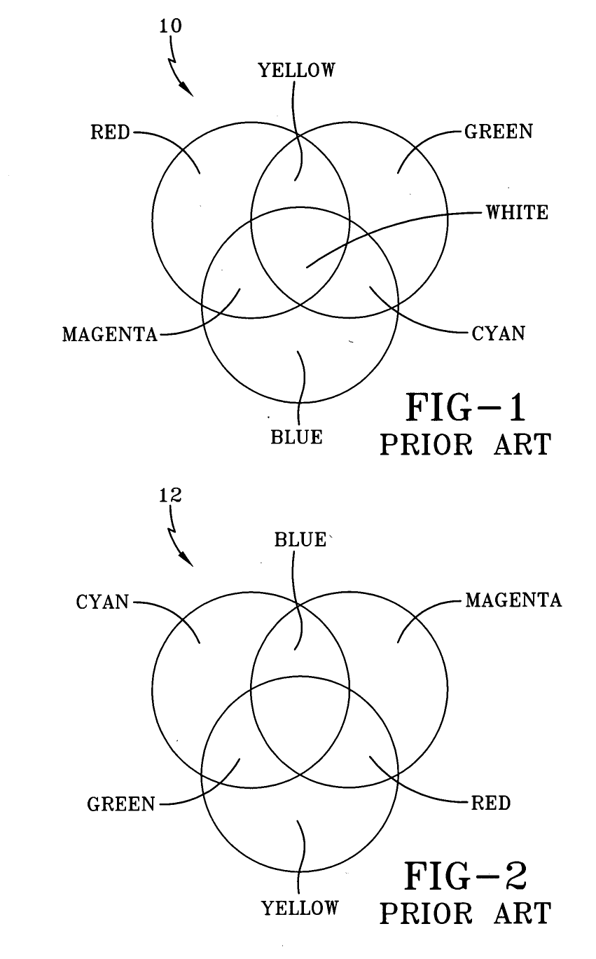

FIG. 2 is a prior art illustration showing the color interactions related to the secondary colors of the RGB and CMYK models;

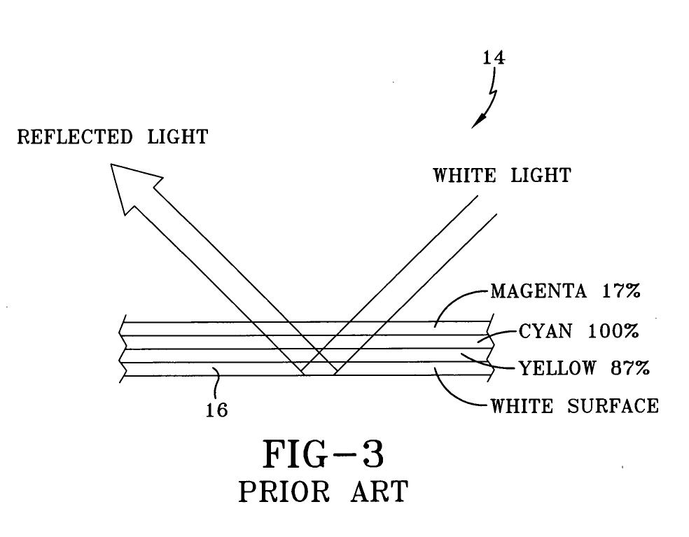

FIG. 3 is a prior art illustration showing the interaction of incident and reflected light associated with the CMYK color model;

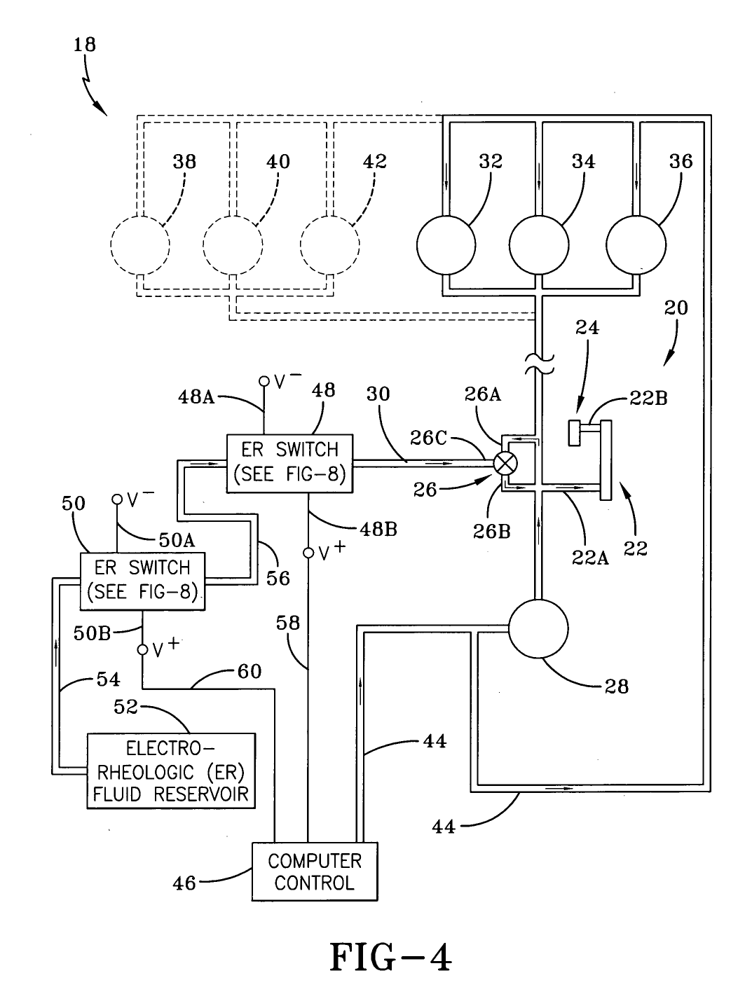

FIG. 4 is a schematic of a single pixel element;

FIG. 5 is a simplified schematic of an array of pixel elements;

FIG. 6. is composed of FIGS. 6A and 6B, wherein FIG. 6A is a top view of a valve making up one of the pixel assemblies of the present invention, and FIG. 6B illustrates a side view of that same valve;

FIG. 7 is composed of FIGS. 7A, 7B, and 7C respectively illustrating the valve of FIG. 6 in its open position, the valve of FIG. 6 in its closed position, and an enlarged view of the diaphragm of the valve mating with the output port of the valve of FIG. 6;

FIG. 8 is a schematic of an electrorhelogic switch in accordance with the present invention;

FIG. 9 is a simplified schematic of a single pixel assembly of the fluidics matrix display of the present invention;

FIG. 10 is a schematic of the addressing scheme for a single pixel chamber of the present invention; and.

FIG. 11 is composed of FIGS. 11A and 11B respectively illustrating a single pixel row/column decode and pixel array row/column decode schemes all related to the present invention.

### DETAILED DESCRIPTION OF THE PREFERRED EMBODIMENTS

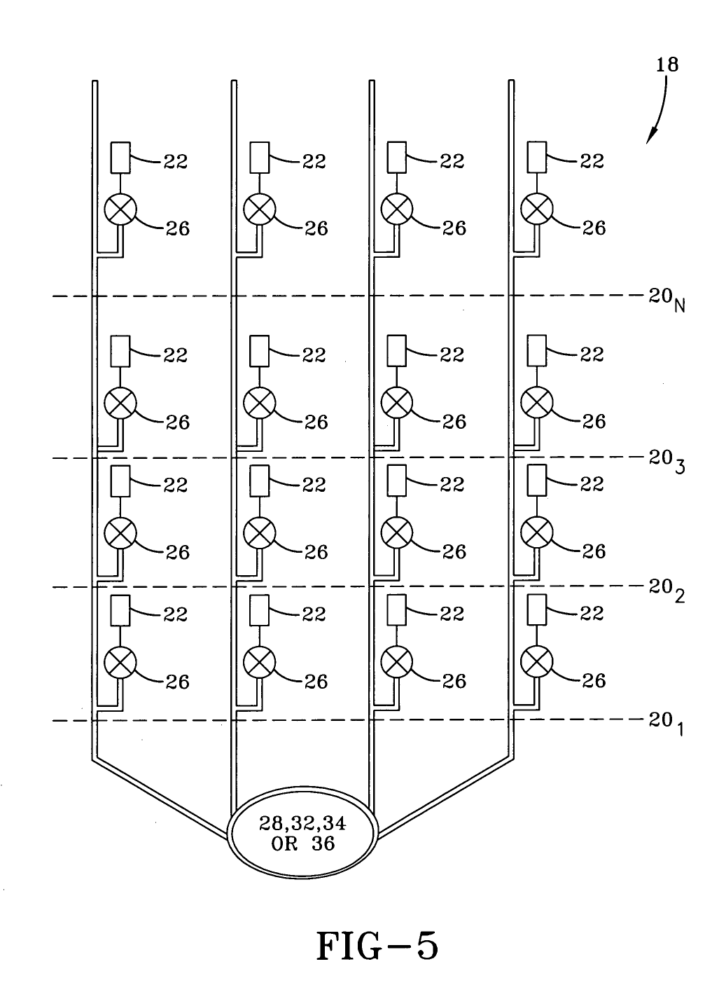

The reflective fluidics matrix display system 18 of the present invention, shown in FIG. 4, is passive, in that, it relies on illumination from outside the display to strike the display and illuminate the image as opposed to an active display that produces illumination for the image from within.

In general, and as will be further described in detail, the fluidics matrix display 18 is a reflective display that utilizes four overlapping layers of colored die to create an image. Each of the four layers corresponds to one color in the CMYK color space. Each of the pixel elements of the fluidics matrix display 18 is individually addressable and is composed of four stacked pixel chambers making up one of the colors in the CMYK color space. More particularly, each of the four-stacked pixel chambers is individually addressable. Each of the four-pixel chambers is valved to admit or expunge the colored fluid or die to or from that chamber. Images are created by writing the appropriate color die data to each of the four-pixel chambers in each pixel element.

A single pixel element 20, shown in FIG. 4, is composed of four pixel chambers 22, four air spring chambers 24, four valves 26 and the pneumatic/hydraulic circuits to separately address each. A single pixel chamber 22, a single air spring chamber 24, a single valve 26 is schematically shown in FIG. 4, along with a single liquid reservoir 28 and a single liquid I/O control port signal 30.

It should be noted, and as will be further described, each pixel chamber 22 can receive a colored fluid from reservoir 28 containing a cyan colored fluid, reservoir 32 containing a magenta colored fluid, reservoir 34 containing a yellow colored fluid, or reservoir 36 containing a black colored fluid operatively cooperating with each other so as to provide the CMYK color space. Alternately, each pixel chamber 22 can receive a colored fluid from reservoir 38 (shown in phantom) a red colored fluid, reservoir 40 (shown in phantom) containing a green colored fluid, or reservoir 42 (shown in phantom) containing a blue colored fluid all colors operatively cooperating with each other so as to provide the RGB color space model. All of the reservoirs 28, 32, 34, 36, 38, 40 and 42 are capable of being selectively pressurized by an appropriate control signal on signal bus 44 generated by computer control 46.

The fluidic matrix display 18 creates an image in the same manner as print media. Dyes or inks from reservoirs 28, 32, 34 and 36 adhering to the CMYK color model are layered together by the use of four pixel chamber 22 to act as the primary colors of a subtractive color system. As an example, white light is passed through magenta ink from reservoir 32 and yellow ink from reservoir 34 that have been layered by the use of two separate pixel chamber 22. The result is Red.

The fluid matrix display 18 is constructed of four independent and identical sections each constituting a pixel element 20 that are intertwined together against a white substrate to form one of the colors of the image being displayed by the fluid matrix display 18. Each section or pixel element 20 corresponds to one of the colors in the CMYK color model. More particularly, each of the four-pixel chambers 22 of the pixel element 20 have contained therein one of the colors of the CMYK color models. These colors are cyan, magenta, yellow and black. Alternatively, the pixel elements 20, that is, three separately arranged pixel chambers 22, and associated reservoirs may be arranged to operatively cooperate with each other to provide the RGB color space model.

Although the fluidic matrix display 18 provides an image using either the CMYK color space model or the RGB color space model, the operation of fluidic matrix display 18 is to be further described for the CMYK color space model with the understanding that the described operation is equally applicable to the RGB color space model.

In operation, and with reference to FIG. 4, one side of each of the pixel chambers 22 is connected to a reservoir 28, 32, 34 or 36 of colored liquid, via the associated valve 26. As shown in phantom in FIG. 4 for reservoir 28, the color liquid flows from reservoir 28 in to an input port 26A of valve 26, out of an output port 26B of valve 26, and then into the one side of the pixel chamber 22. The same type path to one side of the pixel chambers 22 is followed for the other reservoirs 32, 34 and 36. On the other side, the pixel chamber 22 is connected to the air spring chamber 24. Initially, the associated pixel chamber 22 and air spring chambers 24 are filled with air. The pixel chamber 22 is filled with colored liquid by opening the associated valve 26 connecting the colored liquid reservoir to the pixel chamber and pressurizing the colored liquid reservoir, via signal bus 44. This forces the colored liquid through the associated valve 26 and into the pixel chamber 22. The colored liquid entering the pixel chamber 22 displaces the air and forces the colored liquid into the air spring chamber 24 compressing the air in the air spring chamber 24. Equilibrium is achieved when the pressure in the air spring chamber 24 equals the pressure applied to the colored liquid.

Each of the pixel chambers 22 is emptied of liquid by removing the pressure from the colored liquid reservoirs 28, 32, 34 or 36 and allowing the compressed air in the air spring chamber 24 to push the colored liquid out of the pixel chamber 22. Equilibrium is again achieved when the associated air spring chamber pressure equals the colored liquid reservoir pressure of the associated colored liquid reservoirs 28, 32, 34 or 36.

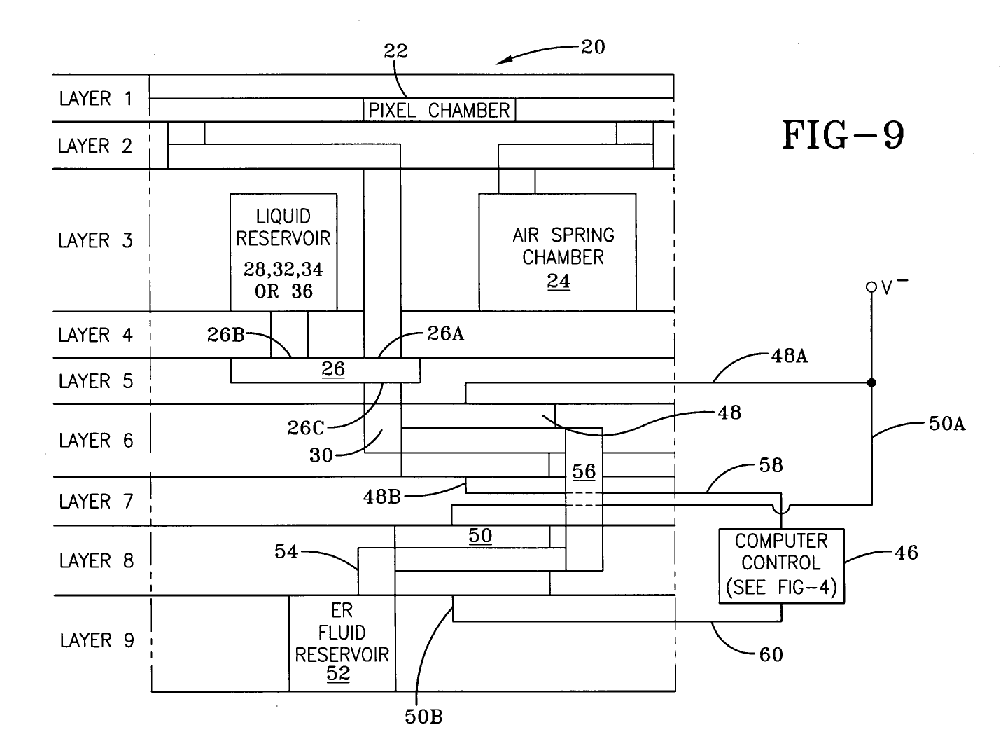

The valve 26 associated with each pixel chamber 22 is positioned to control the flow of colored liquid from the liquid reservoirs 28, 32, 34 or 36 into and out of the pixel chamber 22. The associated valve 26 is preferably opened and closed by a pneumatic signal, such as that of signal 30 that is developed by the operative cooperation of a first and second electrorheologic (ER) switches 48 and 50, respectively, that receive electrorheologic fluid from electrorheologic (ER) fluid reservoir 52 in a serial manner. The ER fluid flows from the ER fluid reservoir 52 to the ER switch 50, via fluid communication path 54 and then from the ER switch 50 to ER switch 48, via fluid communication path 56. Each of the ER switches 48 and 50 is connected to a negative V⁻ or ground potential, via connections 48A and 50A respectively, and to a positive V⁺ potential, via connections 48B and 50B respectively, to an output signal of the computer control 46, via paths 58 and 60, respectively. The operative cooperation of the ER switches 48 and 50, the ER fluid reservoir 52 and computer control 46, will be further discussed hereinafter with reference to FIGS. 8, 9, 10, and 11.

With reference again to FIG. 4, when the valve 26 is closed, no colored liquid may enter the pixel chamber 22 even though the colored liquid reservoirs 28, 32, 34, or 36 has been pressurized. Likewise when the valve 26 is off, no colored liquid may leave the pixel chamber 22, even though the colored liquid reservoirs 28, 32, 34, or 36 has been de-pressurized.

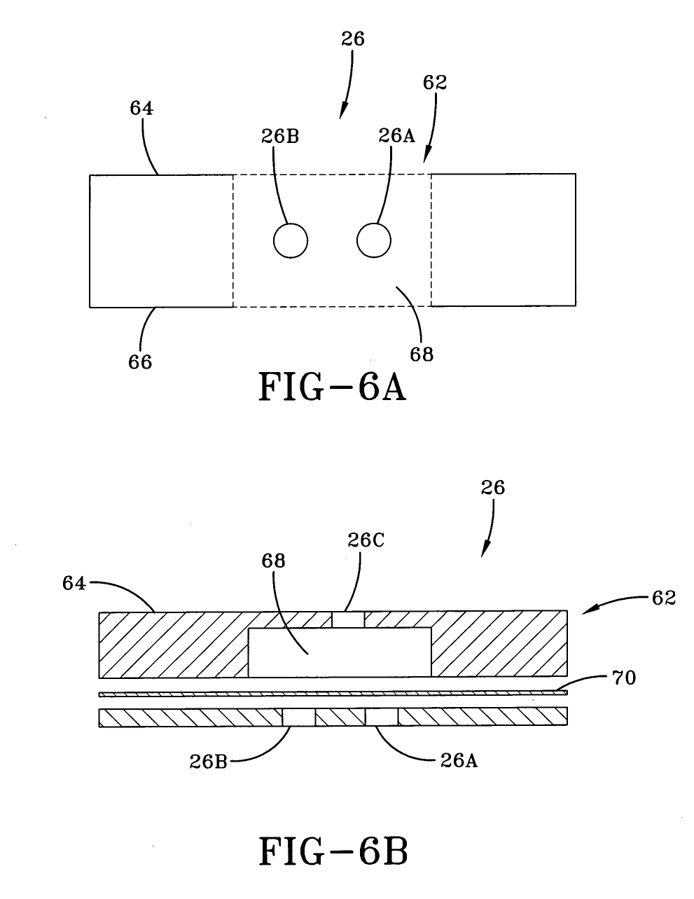

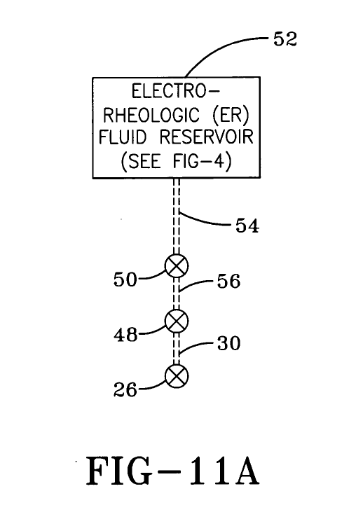

FIG. 5 is a schematic of an array of pixels 20₁, 20₂, 20₃ . . . 20_{N} making up the fluidics matrix display 18. The array of FIG. 5 is shown, for the sake of clarity, as lacking the associated air spring chambers 24 and the addressing arrangement for selectively actuating the valves 26. Each valve 26 is uniquely addressed by a row and column-addressing scheme of the present invention to be further described hereinafter with reference to FIG. 10. Because of this scheme, each valve 26 and therefore each pixel chamber 22 can be written to independently and a resulting image displayed by the visual summation of all of the pixel chambers 22 of all of the pixel elements 20. In one embodiment described herein, the valve 26 controlling flow of colored liquid from the reservoirs 28, 32, 34 or 36 into and out of a pixel chamber 22 is a normally open valve controlled by a pneumatic signal, such as that of signal 30. However, other schemes including normally closed valves 26 and hydraulic control signals are also suitable and contemplated by the practice of the present invention.

As seen in FIG. 4, each of the valves 26 has input, output, and control terminals or ports respectively shown with reference numbers 26A, 26B, and 26C. The input 26A is connected to the reservoirs 28, 32, 34 or 36. The control port 26C is connected to the signal path 30. Each of the pixel chambers 22 has an input and output 22A and 22B, respectively. The input for 22A is respectively connected to the output port 26B of valve 26. Each of the air spring channels 24 has an input port 24A. The input port 24A is connected to the output port 22B of the pixel chamber 22.

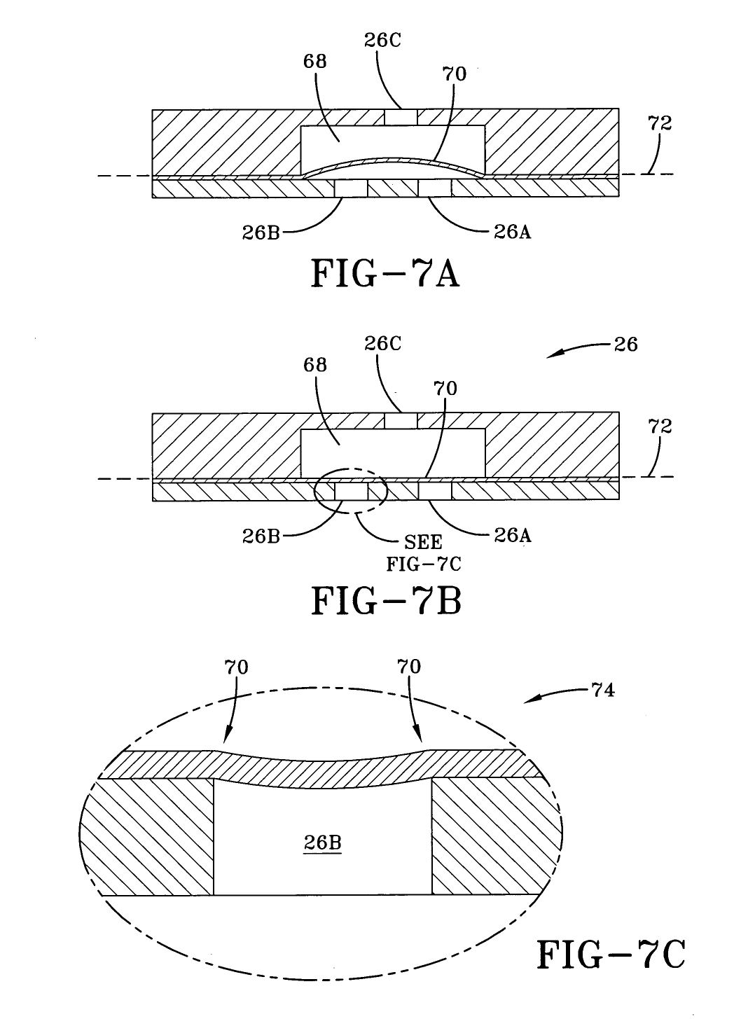

The colors being entered into each of the pixel chambers 22 is controlled by the associated valve 26, which may be further described with reference to FIG. 6 composed of FIGS. 6A and 6B, which are respectively top and side views of valve 26. Each of the valves 26 comprises a body member 62 having at least first and second opposite sides 64 and 66. The valve 26 has a valve chamber 68 (shown in phantom in FIG. 6A) within the body member 62. A first cutout is arranged in the first side 64 and serves as a control port 26C leading into the chamber 68 as shown in FIG. 6B. The valves 26 further have second and third cutouts, respectively, serving as input and output ports 26A and 26B and leading into the valve chamber 68. A diaphragm 70 is interposed between the valve chamber 68 and the input and output ports and 26A and 26B.

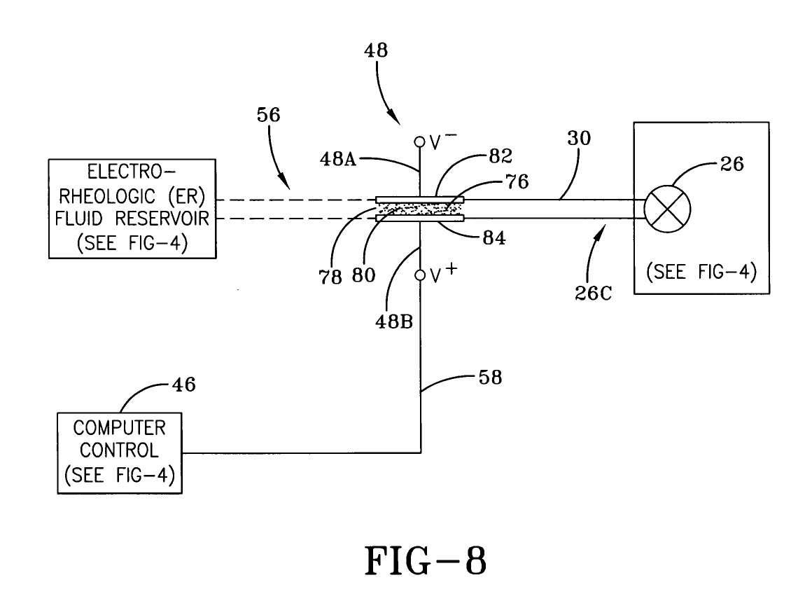

The diaphragm 70 may be a flexible plastic selected from the group comprising polyurethane, vinyl, nylon, and polyethylene. The diaphragm 70 may also comprise a rubber film of the materials selected from the group consisting of latex and silicone. The flexible plastic or rubber film serving as a diaphragm 70 may have a thickness of less than 0.001 inches. The valve 26 may be further described with reference to FIG. 7 composed of FIGS. 7A, 7B, and 7C.

The valves 26, shown in FIG. 7 are three terminal or port devices 26A, 26B, and 26C. These valves 26 may be entirely pneumatic, entirely hydraulic, or a combination of both. For all valves, there is an inlet (26A), an outlet (26B), and a control terminal (26C). A purely pneumatic valve 26 may use a pneumatic control signal 30 (shown in FIG. 4) to gate a pneumatic flow from valve inlet 26A to valve outlet 26B. Similarly, a purely hydraulic valve may use a hydraulic control signal applied to port 26C (shown in FIG. 7) to gate a hydraulic flow from valve inlet 26A to valve outlet 26B. A combination valve may use a pneumatic control signal applied to port 26C to gate a hydraulic flow from valve inlet 26A to valve outlet 26B or a hydraulic control signal to gate a pneumatic flow from valve inlet 26A to valve outlet 26B.

FIG. 7A illustrates the valve 26 in its relaxed or open state, wherein fluid entering input port 26A is routed to output port 26B by means of the diaphragm 70. Conversely, FIG. 7B illustrates the valve 26 in its rigid or closed state, wherein diaphragm 70 prevents any fluid communications between ports 26A and 26B.

As seen in FIG. 7A, both the inlet 26A and outlet ports 26B extend through the valve seat plane 72 and the diaphragm 70 is parallel to the valve seat plane 72. Communication from the inlet port 26A to the outlet port 26B is accomplished when the diaphragm 70 is allowed to move away from the valve seat sealing surface 72 due to the pressure applied by the fluid entering from the inlet port 26A. As seen in FIG. 7B, communication from inlet 26A to outlet 26B is prevented when the diaphragm 70 is pressed against the valve sealing surface 72 by pressure applied to the back of the diaphragm 70 through the signal applied to control port, that is, control port 26C. Sealing is accomplished by the diaphragm 70 conforming to a knife edge arrangement 74 for the outlet port 26B as shown in FIG. 7C.

The addressing scheme of the present invention allows each valve 26, and therefore, each pixel element 20₁ . . . 20ₘ . . . 20ₙ, to be written into independently and a resulting image displayed thereby. In the addressing scheme of the present invention, the valve 26 controlling flow of colored liquid into and out of a pixel chamber 22 is a normally open valve 26 controlled by a hydraulic signal applied to its control port 26C. However, other schemes including normally closed valves and pneumatic control signals are considered to be within the scope of the present invention.

The addressing scheme of the present invention serves two important functions. First, it allows for the independent addressing of each of the four valves 26 comprising a single pixel element 20. It should be recognized that each pixel element is made up of four layers each having a valve 26, a pixel channel 22, and an air spring channel 24. This addressing scheme is necessary to create an image where each pixel element will change from one image to the next image.

For large format billboards handled by the present invention, that are designed to be viewed from a distance of 100 feet or more, the pixel element size is on the order of 0.25-0.5 inch high and of a square nature, although other shapes including rectangular dimensions work as well. The liquid and pneumatic channels, such as the channel 30, are on the order of 0.1 inch in width. The dimensions may be scaled down to produce a higher resolution display suitable for closer viewing. The second important function provided by the addressing scheme of the present invention may be further described with reference to FIG. 8.

FIG. 8 illustrates the basic construction of electrorhelogical (ER) switch 48, as well as the ER switch 50, both previously mentioned with reference to FIG. 4, and wherein FIG. 8 illustrates the arrangement of the ER switch 48 relative to that shown in FIG. 4. Each of ER switches 48 and 50 may be of the type similar to that disclosed in the previously mentioned cross-referenced related U.S. patent application Ser. No. ______ having Attorney Docket No. SP04 filed herewith.

The ER switch 48 modulates the control signal that is applied to path 30 that activates the fluid control valve 26 of FIG. 4. The ER switch 48 comprises a chamber 76 containing electrorhelogical fluid 78 comprised of dielectric particles 80. The container 76 has a roof and a floor and input and output ports respectively shown in FIG. 8 as fluid communication paths 56 and 30. The input port 56 is capable of receiving the electrorhelogical fluid 78.

The ER switch 48 further comprises first and second electrodes 82 and 84 oppositely disposed from each other and respectively located on the roof and on the floor of the chamber 76 as shown in FIG. 8. The electrodes 82 and 84 are two parallel electrodes interposed between the valve inlet port 56 and valve outlet port 30, such that the ER fluid 78 passing through the ER valve 48 must pass through the gap created by the oppositely positioned electrodes 82 and 84. The first electrode 82 is connected to the negative V⁻ or ground potential, via path 48A and the second electrode 84 is connected to the positive potential V⁺ with the positive potential being determined by the generation of the signal applied on signal path 58. The positive potential is routed, via signal path 58, to the computer control 46.

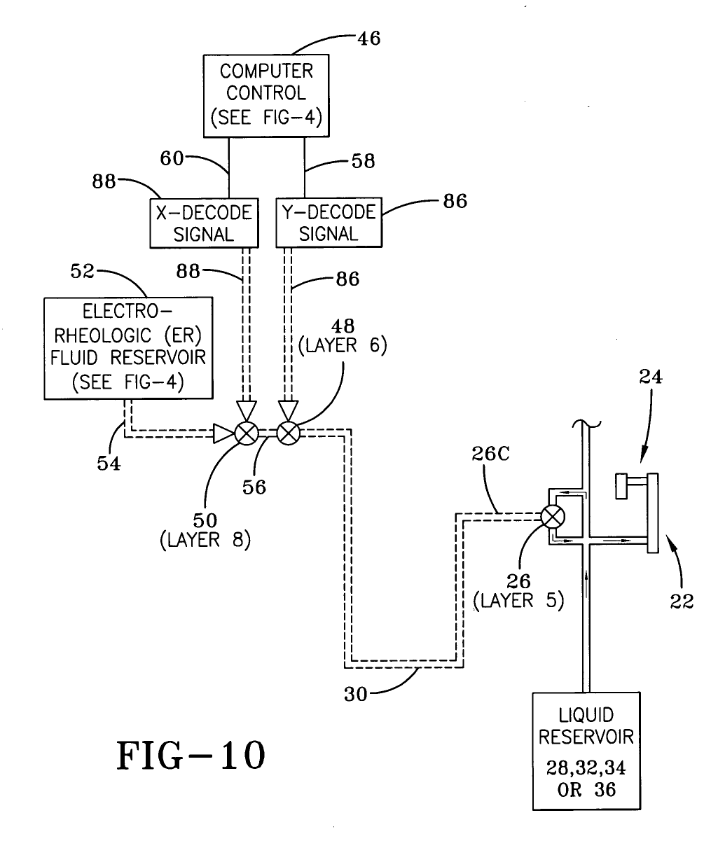

As more fully discussed in U.S. patent application Ser. No. ______ having Docket No. SP04 and herein incorporated by reference, electrorheological (ER) fluids 78 are suspensions of extremely fine dielectric particles 80 up to 100 microns in size in non-conducting fluids. Since the dielectric constant of the suspended particles 80 is larger than the dielectric constant of the base fluid making up the electrorhelogical fluid (ER) 78, an external electric field polarizes the particles. These polarized particles 80 interact and form chains or even lattice like structures. The macroscopic effect is the apparent change in viscosity of these fluids in response to an electric field. A typical ER fluid can go from the consistency of a liquid to that of a solid, and back, with response times on the order of milliseconds. This change in viscosity is proportional to the applied potential across electrodes 82 and 84. The signal to control the ER fluids is the electrical voltage and resulting field across the electrodes 82 and 84 in the narrow gap of the ER switch 48, that is, the spacing between the oppositely located electrodes 82 and 84. The fields required to solidify advanced, higher grade ER fluids 78 are in the range of about 2 KV/mm. This requires the electrode gap, that is the spacing between electrodes 82 and 84, to be in the range of about 0.1 mm for reasonable voltages to be useable. The second important function of the addressing scheme of the present invention may be further described with reference to FIG. 9.

FIG. 9 is a side view of a section of a single pixel element 20 in the fluidics matrix display 18 showing the layering arrangement thereof comprising layers 1-9. More particularly, FIG. 9 only shows one-quarter (e.g., one pixel chamber 22) of a pixel element 20. The three non-shown sections of the pixel element are the same as that shown in FIG. 9. The pixel element 20 is constructed by forming the desired structures in sheets or layers of clear material and laminating the layers together until all the structures embodied in the layers 1-9, have been built up. Examples of materials that could be used are polycarbonate, acrylic, SAN and PVC, both known in the art, but other plastics could also be used. This layering 1-9 is shown diagrammatically in FIG. 9. The structures confined in the layers 1-9 may be formed in the clear materials by machining, molding, pressure forming, pressing and/or any other method common in the plastics forming industry. Non-optically clear materials may be used for some layers also. These layers could include any combination of ceramics or metals.

As seen in FIG. 9, a valve 26 is arranged between layers 5 and 4. Further, as seen in FIG. 9, the previously discussed liquid reservoir 28, 32, 34, or 36 and air spring chamber 24 are both contained in layer 3, while the pixel chamber 22 is contained in the uppermost layer 1 with its contents being visible to the human eye, via the clear layer 1 formed of clear or opaque materials.

FIG. 9 further illustrates the fluid communication path 30 which is the output of the ER valve 48 and as being positioned in layer 6 along with the ER valve 48 itself. The ER valve 48 is shown as having its path 48A connected to the negative or ground potential V⁻. Further, the ER valve 48 is shown as having its conductive 48B, carrying the positive potential V⁺, connected to the computer control 46 by way of signal path 58. The input port of the ER valve 48 is connected to fluid control path 56 which passes through layer 6, 7 and 8 and is connected to the output port of the ER valve 50.

The ER valve 50 is shown as having its path 50A connected the negative or ground potential V⁻, while its conductive path 50B, carrying the V⁺ potential, being connected to the computer control 46 by way of signal path 60. The ER valve 50 has its input port connected to fluid communication path 54 located in layer 8 and which interconnects the ER fluid reservoir 52 located in layer 9 to the ER valve 50 located in layer 8.

FIG. 9 illustrates that the interconnection between the liquid reservoir 28, 32, 34 or 36, pixel chamber 22, air spring chamber 24 is controlled by the valve 26 in layers 4 and 5. FIG. 9 further illustrates that the control valve, in particular, the control port 26C is controlled by the pressure signal present in fluid communication path 30 which, in turn, is controlled by the output of the ER valve 48. The output of the ER valve 48 is controlled by the pressure signal present in fluid communication path 56 which, in turn, is controlled by the output of the ER switch 50. The output of the ER switch 50 is controlled by the pressure signal present in fluid communication path 54 which is the output of the ER fluid reservoir 52. The operation of the addressing scheme, which is of particular importance to the present invention, may be further described with reference to FIG. 10.

FIG. 10 is a schematic illustration of the elements in signals previously described with reference to FIGS. 4 and 9. The interconnection of the computer control 46 to the fluid reservoir 28, 32, 34 and 36 is not shown in FIG. 10 for the sake of clarity, but is present and established in the manner known in the art. It should be noted that FIG. 10 illustrates two serially arranged ER switches 48 and 50 for each control valve 26 for each individual pixel chamber 22 making up each pixel assembly 20₁ . . . 20_{N} of the fluidics matrix display 18.

FIG. 10 further illustrates signals 86 (Y-Decoder signal) at 88 (X-Decoder signal) respectively present on signal paths 58 and 60 of the computer control 46.

The colored liquid valve 26, shown in FIG. 10, behind each pixel chamber 22 is positioned to control the flow of colored liquid from the liquid reservoir 28, 32, 34, or 36 into and out of the pixel chamber 22. The X and Y decoder circuit, represented by signals 86 and 88 of FIG. 10, is used to generate the control signal that is applied to the colored liquid valve control port 26C, via fluid communication path 30. In one embodiment, the colored liquid valve 26 is normally open. It is closed by a hydraulic signal that is gated or controlled by the X and Y decoder circuit represented by signals 86 and 88. FIG. 10 is a schematic of both the colored liquid circuit and the X and Y decoder scheme for a single pixel element.

As shown in FIG. 10, there are two electrorheologic (ER) switches or valves 48 and 50 that gate the application of the control signal, via fluid communication path 30, to the colored liquid valve 26 control port 26C. The ER valves 48 and 50, as used in this embodiment, are force transmission devices. The working fluid within the ER valve is ER fluid. However, the flow of ER fluid through the valve 48 or 50 is minimal. The purpose of the ER valve 48 or 50 is to allow the pressurized ER fluid at the valve inlet to pressurize or not pressurize the ER fluid at the valve outlet of ER valves 48 or 50. In this way, the force of the pressurized ER fluid at the valve inlet of ER valve 48 or 50 is either transmitted or not transmitted to the valve outlet of ER valve 48 or 50. The flow of ER fluid through the ER valve 48 or 50 is only enough to compress the ER fluid to the desired pressure applied at the control port 26C of valve 26 of FIG. 10 so as to render operation thereof.

In the embodiment shown in FIG. 10, the ER valve 48 or 50 is a normally open valve without any voltage signals applied to the control gate, that is, applied across electrodes 82 and 84 thereof. Application of a sufficiently large electric field across the electrodes 82 and 84 causes the ER fluid within ER valve 48 or 50 to stiffen to the point where the ER fluid will not move in response to an applied pressure at the valve inlet, that is, by way of fluid communication paths 54 or 56. Removal of the voltage across the electrodes 82 and 84 allows the ER fluid within ER valve 48 or 50 to again liquefy allowing the transmission of the applied pressure at the valve inlet to the valve outlet, thus, causing a pressure signal to be applied to the control port 26C of valve 26 of FIG. 10 rendering it operative.

Each ER valve 48 or 50 is uniquely addressed by a row and column addressing scheme represented by signals 86 and 88 of FIG. 10. Because of this, each ER valve 48 or 50 and therefore each pixel of each pixel assembly 20₁ . . . 20_{N} can be written to independently and a resulting image displayed. In the embodiment shown in FIG. 10, the ER valves, such as 48 and 50, associated with each colored liquid valve, such as valve 26 of FIG. 10, controlling flow of colored liquid into and out of a pixel chamber 22 are normally open valves controlled by an electrical signal represented by signal 86 or 88. However, other schemes including normally closed valves are contemplated by the practice of the present invention.

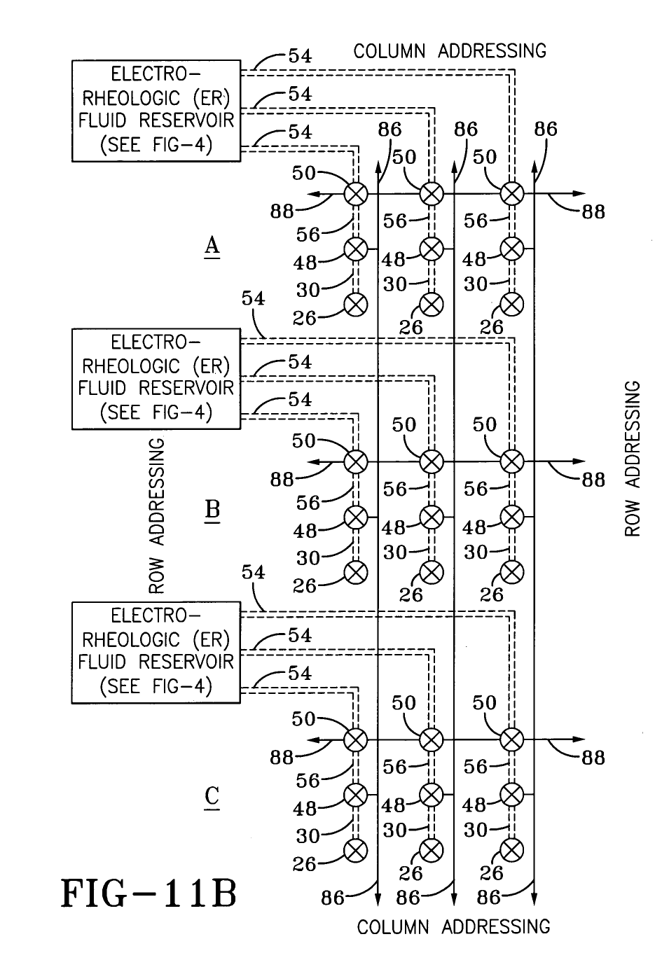

The row and column addressing scheme of the present invention may be further described with reference to FIG. 11 composed of FIGS. 11A and 11B, wherein FIG. 11A is a schematic of the single pixel row/column decode scheme and FIG. 11B is a schematic of a pixel array row/column decode scheme.

FIG. 11A is a simplified version of the showing of FIG. 10 in wherein the control fluid flows from the electrorhelogic fluid reservoir 52 to the ER valve 50, via fluid control path 54, to ER valve 48, via fluid control path 56, and finally to the color control valve 26, via fluid path 26. The ER valve 50 in one embodiment is associated with a row decode, whereas the ER valve 48 is associated with a column decode.

FIG. 11B illustrates an arrangement of three segments A, B, and C, wherein each segment includes three groups of the ER valves 50 and 48 and color valves 26, each fluidly interconnected as more clearly shown in FIG. 11A.

FIG. 11B further illustrates that the column addressing is controlled by the control signal 86 generated by the computer control 46, not shown, whereas the row addressing is controlled by the control signal 88 generated by the computer control 46 (not shown).

The operation of the arrangements of FIGS. 10 and 11 may be further described by first assuming a starting point, that is, a fully de-pressurized state where all pixel chambers 22 of all pixel assemblies 20₁ . . . . 20_{N} are devoid of all colored liquids and the entire display when viewed normal to the display surface will appear white (due to the background) or devoid of color. In the description to follow, a high state refers to either a pressurized state for a pneumatic/hydraulic signal or a high voltage for an electrical signal. A low state refers to a de-pressurized state for a pneumatic/hydraulic signal or a low voltage (e.g., ground) for an electrical signal.

With reference again to FIGS. 10 and 11, no matter what state a pixel is to be put into, the first step is to “close” all ER valves 48 and 50. This is done by raising the voltage to all ER valves 48 and 50. More particularly, by raising the potential across electrodes 82 and 84 by way of signals 86 and 88 generated by computer control 46. This voltage creates an electric field across the gap through which the ER fluid moves within the ER valves 48 and 50. This field stiffens the ER fluid to the point it will not flow through the ER valve 48 or 50. This, in effect, closes the ER valves 48 and 50 and does not allow for the transmission of a pressure signal through the ER valves 48 and 50, so that fluid communication path 30 is devoid of pressure. The next step is to pressurize the electro-rheologic fluid (i.e., ER fluid) that feeds all the ER valves 48 and 50 and that appears at the inlet to all the ER valves. More particularly, pressurize the ER fluid reservoir 52.

This pressurization is done globally, that is, all ER valves 48 and 50 that are associated with all individual pixels of all pixel assemblies 20₁ . . . 20_{N} are pressurized. For those pixels that are to be written as zeros or devoid of color, the next step is to select the pixel, via the row and column addressing scheme, that is, have the computer control 46 selects the particular signal 86 and 88 for the particular pixels of the pixel assemblies 20₁ . . . 20_{N} to be serviced.

As previously mentioned with reference to FIG. 11 and now with reference to FIG. 10, ER valve 48 is designated for column selection and ER valve 50 is designated for row selection. A selected pixel chamber 22 is isolated from its colored liquid source by closing its colored liquid valve 26 by taking the appropriate column electrical signal low or to ground, that is, remove the V⁺ potential on path 48B. This removes the field from the column ER valve 48, that is, removes the field across the electrodes 82 and 84 of the associated ER valve 48. Then the row electrical signal is taken low or to ground for the individual pixels or the pixel assemblies 20₁ . . . 20_{N} to be serviced. This removes the field from the row ER valve 50.

With both the column and row ER valves 48 and 50 for each pixel of the associated pixel assembly 20₁ . . . 20_{N} disabled, the ER fluid within the valve chamber 76 of the associated valves 48 and 50 is allowed to pressurize. This shuts off the associated colored liquid valve 26, by way of the pressurized signal now in fluid communication path 30, and prevents colored liquid from entering the associated pixel chamber 22 of the pixel assembly being serviced. After the ER fluid at the control gate 26C of the associated color valve 26, that is in fluid communication path 30, of the colored liquid valve is pressurized, both the column and row electrical signals 86 and 88 of FIG. 10 are reapplied to the associated ER valves 48 and 50. This solidifies the ER fluid between the ER valves 48 and 50, that is in fluid communication path 56, preventing the pressurized ER fluid at the control gate, that is in fluid communication path 30, of the colored liquid valve 26 from depressurizing even if the global ER fluid pressure is removed. More particularly, even if the pressure at the output of the ER fluid reservoir 52 is removed.

As long as both ER valves 48 and 50 associated with each given pixel of each pixel assembly 20₁ . . . 20_{N} are not turned off at the same time, the ER fluid at the control gate 26C, that is the associated fluid communication path 30, of the colored liquid valve 26 will not be pressurized and the colored liquid valve 26 will remain in the on state capable of passing colored liquid to the respective pixel chamber 22 of the pixel assembly 20₁ . . . 20_{N} being serviced. For a pixel chamber 22 that is to be completely filled with colored liquid, the respective valves 48 and 50 will never be turned off at the same time and the ER fluid at the control gate 26C, that is the associated fluid communication path 30, of the colored liquid valve 26 will always be depressurized.

Now that the two ER valves 48 and 50 for the above example have been used to set the colored liquid valve 26, the pressure on the colored liquid is raised by pressurizing the associated color liquid reservoir 28, 32, 34, or 36. However, the pixel chamber 22 described above will not fill with colored liquid because its associated colored liquid valve 26 has been closed, via the pressurized ER fluid present in the fluid communication path 30.

For any pixel chamber 22 that is to be partially filled with liquid, the respective ER valves 48 and 50 are momentarily turned off as the pressure on the colored liquid is being raised. For a pixel chamber 22 that is to be half filled, the respective ER valves 48 and 50 are momentarily turned off as the colored liquid pressure reaches half its maximum value.

For the embodiment shown in FIG. 10, the row and column valves 48 and 50 behind each colored liquid valve 26 and pixel chamber 22 have been described as being electrorheologic valves. However, magneto-rheologic valves are contemplated by the practice of the present invention.

It should now be appreciated, that the practice of the present invention provides for a relatively simple switching arrangement to control the activation of pixel assemblies of the fluidics matrix display 18, while at the same time reducing the number of pneumatic valves that are involved.

It should be further appreciated that the practice of the present invention provides a fluidics matrix display 18 that utilizes a CMYK or RGB color process involving the direction of colored fluids specified for each process. The fluidics matrix display 18 being a passive device provides benefits that serve large format applications found in both indoor and outdoor advertising.

Further, it should be appreciated that the practice of the present invention provides individually addressable pixel elements composed of four stacked pixel chambers, and with each pixel chamber being valved to admit or expunge the colored dye to and from the pixel chamber. The admitting and expunging being controlled by the utilization of electrorheologic fluids.

The invention has been described with reference to the preferred embodiments and alternatives as thereof. It is believed that many modifications and alternations to the embodiments as discussed herein will readily suggest themselves to those skilled in the art upon reading and understanding the detailed description of the invention. It is intended to include all such modifications and alterations insofar as they come within the scope of the present invention.

What we claim is:

1. A fluidics matrix display comprising:
a) a plurality of pixel elements each comprising:
a₁) a plurality of pixel chambers stacked on each other and with each pixel chamber having an input port and an output port;
a₂) a plurality of air spring chambers each having an input port connected to a respective output port of said plurality of pixel chambers; and
a₃) a plurality of valves each having input, output, and control ports and each control port being responsive to a control signal so as to interconnect its input to its output port, said output ports thereof being connected to a respective input port of said plurality of said pixel chambers;
b) a plurality of sources of pressurized colored fluids respectively connected to a respective input port of said plurality of valves; and
c) an electrorhelogical switch for generating said control signal, said electrorhelogical switch comprising:
c₁) a chamber having a roof and a floor and input and output ports, said input port being capable of receiving electrorhelogical fluid; and
c₂) first and second electrodes oppositely disposed from each other and respectively located on said roof and on said floor; said first electrode being capable of being connected to a negative or ground potential and of said second electrode being capable of being connected to a positive potential with said positive potential being deterministic of the generation of said control signal.

2. The fluidics matrix display according to claim 1, wherein said plurality of sources of pressurized color fluids consist of colors red, green and blue.

3. The fluidics matrix display system according to claim 1, wherein said plurality of sources of pressurized color fluids consist of the colors cyan, magenta, yellow and black.

4. The fluidics matrix display according to claim 3, wherein said plurality of pixel chambers consist of four layers and wherein said four pixel chambers are respectively connected to said cyan colored fluid, said magenta colored fluid, said yellow colored fluid, and said black colored fluid.

5. The fluidics matrix display according to claim 1, wherein each of said valves comprises:
a) a body member having at least first and second opposite sides;
b) a valve chamber located within said body member;
c) a first cutout in said first side and serving as said control port and leading into said valve chamber;
d) second and third cutouts in said second opposite side and respectively serving as said input and output ports and each leading into said valve chamber; and
e) a diaphragm interposed between said valve chamber thereof and said input and output ports thereof.

6. The fluidics matrix display according to claim 5, wherein said diaphragm is a flexible plastic selected from the group consisting of polyurethane, vinyl, nylon and polyethylene.

7. The fluidics matrix display according to claim 5, wherein said diaphragm is a rubber film of a material selected from the group consisting of latex and silicone.

8. The fluidics matrix display according to claim 1, wherein said chamber is dimensioned so that a gap between said first and second electrodes is about 0.1 mm and a potential difference between said negative or ground potential and said positive potential creates a field between said first and second electrodes in the range from about 0 to about 2 KV/mm.

9. A method of displaying images for human viewing comprising the steps of:
a) providing a plurality of pixel elements each comprising:
a₁) a plurality of pixel chambers stacked on each other and with each pixel chamber having an input port and an output port;
a₂) a plurality of air spring chambers each having an input port connected to a respective output of said plurality of pixel chambers; and
a₃) a plurality of valves each having input, output and control ports and each control port being responsive to a first control signal so as to interconnect its associated input to its associated output port, said output ports thereof being connected to a respective input port of said plurality of said pixel chambers;
b) providing an electrorhelogical switch for generating said control signal, said electrorhelogical switch comprising:
c₁) a chamber having a roof and a floor and input and output ports, said input port being capable of receiving electrorhelogical fluid; and
c₂) first and second electrodes oppositely disposed from each other and respectively located on said roof and on said floor, said first electrode being capable of being connected to a negative or ground potential and said second electrode being capable of being connected to a positive potential with said positive potential being deterministic of said generation of said control signal;
d) providing a source of electrorhelogic fluid;
e) connecting said source of electrorhelogic fluid to said input port of said chamber;
f) connecting said first electrode to said negative or ground potential;
g) providing a plurality of sources of pressurized colored fluids;
h) connecting said plurality of sources of pressurized colored fluids to a respective input port of said plurality of valves;
i) providing a computer signal that provides a positive potential having an output;
j) connecting said second electrode to said output signal of said computer; and
k) operating said computer to selectively generate said output signal to serve as said control signal so that colored fluids enter and leave each of said pixel chambers in a predetermined manner to produce an image for said human viewing.

10. The method of displaying images according to claim 9, wherein said chamber is provided so that it is dimensioned to provide a gap between said first and second electrodes of about 0.1 mm, and said computer is provided so that its output signal causes a potential difference between said negative or ground potential and said positive potential to create a field between said first and second electrodes in the range from about 0 to about 2 KV/mm.
